(19) United States
(12) Patent Application Publication
(10) Pub. No.: US 2010/0064515 A1
(43) Pub. Date: Mar. 18, 2010

(54) METHOD FOR REPAIRING AND/OR REPLACING INDIVIDUAL ELEMENTS OF A GAS TURBINE COMPONENT

(75) Inventors: Wolfgang Eichmann, Puchheim (DE); Falko Heutling, Muenchen (DE); Thomas Uihlein, Dachau (DE); Alexander Gindorf, Schwabhausen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/307,704

(22) PCT Filed: Jun. 30, 2007
(86) PCT No.: PCT/DE2007/001166

§ 371 Date: Oct. 19, 2009

(30) Foreign Application Priority Data
Jul. 7, 2006 (DE) 10 2006 031 388.7

(51) Int. Cl. B23P 6/00

(52) U.S. Cl. 29/889.1

(57) ABSTRACT

The present invention relates to a method for repairing and/or replacing individual elements of a gas turbine component (10), particularly for repairing and/or replacing a blade or blade part arranged on a rotor support of a gas turbine, at least some of the components (10) being provided with at least one wear-resistant and/or erosion-resistant layer and the method comprising the following steps:
a) a coated or uncoated individual element that is damaged and/or needs to be replaced is removed from the component (10); b) a coated, partially coated or uncoated replacement element (12) is provided; c) the replacement element (12) is fed and aligned relative to the component (10); and d) the replacement element (12) is connected to the component (10), corresponding contact areas (20, 22) of the replacement element (12) and the component (10) being connected by means of an inductive low-frequency or high-frequency pressure welding process.

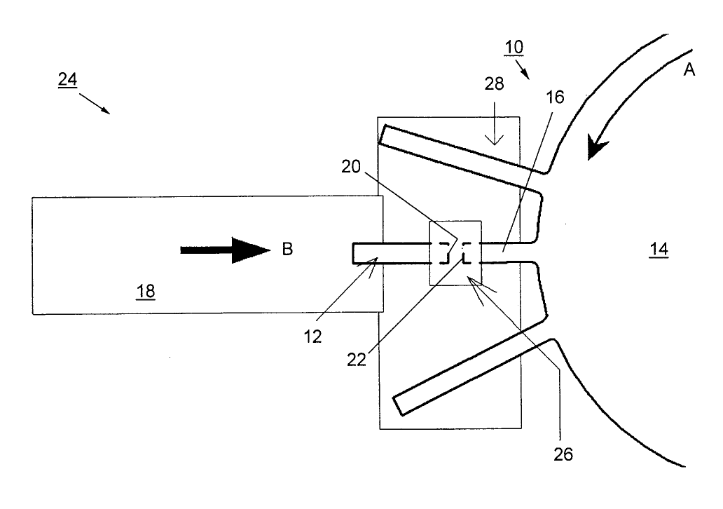

This application claims the priority of International Application No. PCT/DE2007/001166, filed Jun. 30, 2007, and German Patent Document No. 10 2006 031 388.7, filed Jul. 7, 2006, the disclosures of which are expressly incorporated by reference herein.

### BACKGROUND AND SUMMARY OF THE INVENTION

The present invention relates to a method for repairing and/or replacing individual elements of a gas turbine component, particularly for repairing and/or replacing a blade or blade part arranged on a rotor support of a gas turbine, at least some of the components being provided with at least one wear-resistant and/or erosion-resistant layer.

Different methods and devices for connecting metallic structural components by means of an inductive high-frequency pressure welding process are known from the prior art. Thus, for example, German Patent Document No. DE 198 58 702 A1 describes a method for connecting uncoated blade parts of a gas turbine, wherein one blade section and at least one other blade part are made available. In the process, corresponding contact areas of these elements are essentially positioned aligned and spaced apart from one another and then welded together by exciting an inductor with high-frequency current and moving them together making contact with their contact areas. In the process, the inductor is excited with a constant frequency, which is generally above 0.75 MHz. In addition, the frequency is selected as a function of the geometry of the contact areas. In the case of inductive high-frequency pressure welding, the simultaneous and homogeneous heating of the two welding mates is of crucial significance for the quality of the joint. The finished components are coated with wear-resistant and erosion-resistant layers. These may be hard material layers in particular. Wear-resistant layers, such as, for example, anticorrosive layers and antioxidant layers, are known and are used in particular in parts of turbines or aircraft engines as well as combustion chambers. So-called MCrAlY coating layers, such as those described in U.S. Pat. No. 4,080,486, European Patent Document No. EP-B1-0486489 and U.S. Pat. No. 4,585,481, are used as hot anticorrosive layers. Moreover, these MCrAlY coating layers may be used as an adhesion-promoting layer or a bonding layer between the metallic substrate on which the protective layer is applied and a ceramic top layer. In this case, the protective layer is applied in particular by a thermal spray process, such as, for example, flame spraying, high-speed flame spraying, detonation spraying, plasma spraying, electric arc spraying, laser spraying or molten bath spraying.

Repairing or replacing components of a gas turbine that have been coated in this manner makes particular demands on technology because the wear resistance and erosion resistance of these types of components must absolutely remain intact after a repair or a replacement. Thus, for example, a gas turbine blade is repaired by a complete removal of the coating, followed by repair and subsequent recoating of the corresponding component. This is associated with disadvantageously high costs from decoating and coating as well as from laboriously masking off areas that may not come into contact with the decoating solution. Furthermore, there is a high risk of abrasion of the base material of the component from the decoating solution. In addition, attempts may be made to perform the repair with conventional joining processes such as micro-plasma welding or laser powder application welding. However, prior decoating of the component is also necessary in this case, because the wear-resistant or erosion-resistant layer otherwise becomes embedded in the areas of the base material that are being melted. Along with the massive impact of heat on components with smaller material cross sections, such as blades for example, there are undefined negative effects on the structure of the component due to the incorporation of the layer elements. Furthermore, in the case of conventional joining processes, a great distance must be maintained from critical zones of the component due to the relatively large heat impact zone. These types of zones are for example zones with the greatest erosion stress of the components. Because of the set of problems described, it is common to scrap individual gas turbine blades that have been coated with wear-resistant or erosion-resistant layers after the layer has been used up. The cause of this is also that, particularly in the case of ceramic layers like TiN, the protective layers are electrochemically very noble as compared to normal compressor materials such as titanium alloys and therefore they can scarcely be removed without the base material being attacked. In addition, some of the described de-coating solutions cannot be used, because they are injurious to the environment and/or health. In the case of integral components such as BLISK compressors, the scrapping represents a high loss of value, because even the undamaged parts, such as, for example, the disc of the compressor, are also lost.

As a result, the objective of the present invention is providing a generic method for repairing and/or replacing individual elements of a gas turbine component, which guarantees a quick, cost-effective, secure and permanent connection of coated gas turbine elements.

An inventive method for repairing and/or replacing individual elements of a gas turbine component, particularly for repairing and/or replacing a blade or blade part arranged on a rotor support of a gas turbine, at least some of the components being provided with at least one wear-resistant and/or erosion-resistant layer, is comprised of the following steps: a) a coated or uncoated individual element that is damaged and/or needs to be replaced is removed from the component; b) a coated, partially coated or uncoated replacement element is provided, with the replacement element being comprised of a material that is of the same kind as the individual element or more wear-resistant; c) the replacement element is fed and aligned relative to the component; and d) the replacement element is connected to the component, corresponding contact areas of the replacement element and the component being connected by means of an inductive low-frequency or high-frequency pressure welding process. In the case of connecting an uncoated replacement element, the uncoated replacement element may be subsequently coated. The inventive use of the inductive low-frequency or high-frequency pressure welding process allows the corresponding individual elements to be repaired and/or replaced without prior decoating of the component elements and correspondingly laborious masking efforts. In this case, the repair can also be advantageously performed very close to mechanically critical zones of the component being repaired because of the small heat impact zone, which occurs in the case of inductive low-frequency or high-frequency pressure welding process. This, in turn, produces the advantage that, in these areas in which erosion hardly occurs, potentially missing protective layer areas have hardly any or no effect. In addition, because of the inductive low-frequency or high-frequency pressure welding process, residue from the protective layers is pushed outwards, i.e., out of the area of the joining zone and/or the contact areas being connected, so that there is no layer build-up in the base material of the replacement element or of the component. Prior removal of the protective layer is also not required as a result. In addition, the inventive method makes it possible to dispense with complex repair processes, such as patching or deposit welding with individual geometries, which are associated with high validation and safeguarding expense, because the replacement of individual elements, such as blades, can be executed comparatively simply and in a standard manner. In addition, there is advantageously the possibility that even uncoated replacement elements may be connected to already coated areas of the component and then be coated afterwards with a corresponding wear-resistant or erosion-resistant layer. Overall the inventive method guarantees a quick, secure and permanent connection of gas turbine elements that are at least partially coated.

In an advantageous embodiment of the method, the feeding of at least one replacement element, particularly the blade or blade part, takes place automatically from at least one replacement element reservoir, particularly a blade reservoir and/or a blade part reservoir. High production rates are guaranteed by making the replacement elements available in a corresponding reservoir, for example a magazine device.

In a further advantageous embodiment of the inventive method, the replacement element is fed to a clamping device, with the contact area of the replacement element being moved and pressed against the corresponding contact area of the component by the clamping device. The clamping device, on the one hand, guarantees that the replacement element is moved in correct position toward the component. In addition, the clamping device applies the necessary compressive force on the replacement element without the replacement element being subjected to an excessive compressive load. In this case, the replacement element may be a blade or a blade part, which is being fed to a corresponding contact area of a rotor support or of a blade connection of the rotor support.

In another advantageous embodiment of the inventive method, a position and location check of the replacement element and/or of the component is performed before and during the movement of the replacement element against the component. The position and location check may be performed in this case by an optical measuring device. This results in an exact positioning of the joining mates for joining the replacement element in a manner that is close to the final contour, in particular for positioning the blade on the rotor support.

In a further advantageous embodiment of the inventive method, the frequencies used in the inductive low-frequency or high-frequency pressure welding process are selected from a range between 0.05-2.5 MHz. In the process, at least two different frequencies may be induced. It has surprisingly emerged that not only relatively high frequencies, but also correspondingly lower frequency ranges may be used for the inductive frequency pressure welding. The use of different frequencies depends in particular on the geometry of the components being joined, in particular the corresponding cross-sectional geometries of the mates being joined. By using different frequencies, a simultaneous and homogeneous heating of the two welding mates may be performed even in the case of more complex geometries. This is of crucial importance for the quality of the joint.

An inventive component is manufactured in accordance with a method described in the foregoing. These components are so-called BLINGs (bladed rings) or BLISKs (bladed discs) of gas turbine engines.

Additional advantages, features and details of the invention are disclosed in the subsequent description of an exemplary embodiment depicted graphically in the FIGURE.

### BRIEF DESCRIPTION OF THE DRAWING

The FIGURE shows a schematic representation of a device for performing the inventive method.

### DETAILED DESCRIPTION OF THE DRAWING

The FIGURE shows a device 24 for connecting at least one coated replacement element 12, namely a blade, to a component 10. The component 10 in this case is a so-called BLISK. Connecting the blade 12 takes place in this case with a rotor support 14 of a gas turbine, namely a blade connection 16 of the rotor support 14, wherein the connecting of corresponding contact areas 20, 22 of the blade 12 and of the blade connection 16 is accomplished by an inductive low-frequency or high-frequency pressure welding process. The preceding procedural step a), namely removing a coated or uncoated individual element that is damaged and/or needs to be replaced from the coated component 10 is not shown in the FIGURE.

The device 24 is comprised of a generator 28 for generating the required welding energy and an inductor 26. The contact areas 20, 22 of the replacement element 12 and/or of the blade 12 and the blade connection 16 are heated by exciting the inductor 26 with high-frequency current. In this case, heating occurs up to at least near the melting point of the materials from which the blade 12 and the blade connection 16 are manufactured. In the depicted exemplary embodiment, the blade connection 16 is embodied on the circumference of a disc. In this case, the disc represents the so-called BLISK rotor.

In addition, one can see that a clamping device 18 presses the replacement element 12 or the blade 12 in arrow direction B against the blade connection 16.

Moving the blade 12 toward the blade connection 16 is accomplished in this case by sufficiently great heating of the contact areas 20, 22. This is the case when the contact areas 20, 22 are almost molten and reach a doughy state.

The rotor support 14 may be positioned on a rotary table (not shown). The rotary table and thus the rotor support 14 are rotated in the process in arrow direction A around a defined angle dimension. The result of this is an exact positioning of the blade connection 16 to the blade 12 or an exact positioning of the corresponding contact areas 20, 22 to one another. Furthermore, the perpendicular arrangement of the blade 12 in the device 24 results in the accessibility of the weld junction with an induction coil arranged on the rear side for small and large cross sections. Normally, the welding area is in an inert atmosphere, which is either locally generated or can include the entire welding area.

In addition, the device 24 includes at least one feed device for automatically feeding the replacement elements 12 and/or the blades 12 from a blade reservoir (not shown).

The blade 12, the blade parts or the rotor support 14 may be comprised in this case of different or similar metallic materials. However, it is also possible for the cited structural elements to be comprised of similar metallic materials and be manufactured by different manufacturing methods. This relates for example to forged structural elements, structural elements produced by casting methods, structural elements comprised of single crystals as well as directionally solidified structural elements.

The exemplary embodiment makes it clear that the inventive method is suitable both for manufacturing as well as repairing components of a gas turbine.

1-11. (canceled)

12. A method for repairing and/or replacing an individual element of a gas turbine component, particularly for repairing and/or replacing a blade or blade part arranged on a rotor support of a gas turbine, at least some of the components being provided with at least one wear-resistant and/or erosion-resistant layer, comprising the steps of:
a) a coated or uncoated individual element that is damaged and/or needs to be replaced is removed from the component;
b) a coated, partially coated, or uncoated replacement element is provided, the replacement element being comprised of a material that is of a same kind as the individual element or of a material that is more wear-resistant than a material of the individual element;
c) the replacement element is fed and aligned relative to the component; and
d) the replacement element is connected to the component, wherein corresponding contact areas of the replacement element and the component are connected by an inductive low-frequency or high-frequency pressure welding process.

13. The method according to claim 12, wherein a coating of an uncoated replacement element takes place after step d.

14. The method according to claim 12, wherein the step of feeding the replacement element takes place automatically from a replacement element reservoir.

15. The method according to claim 14, wherein the replacement element is a blade or blade part and wherein the replacement element reservoir is a blade reservoir and/or a blade part reservoir.

16. The method according to claim 12, wherein the replacement element is fed to a clamping device and wherein a contact area of the replacement element is moved and pressed against a corresponding contact area of the component by the clamping device.

17. The method according to claim 16, wherein the replacement element is a blade or blade part and wherein the component is a rotor support or a blade connection of a rotor support.

18. The method according to claim 12, wherein a position and location check of the replacement element and/or of the component is performed before and during a movement of the replacement element against the component.

19. The method according to claim 18, wherein the position and location check is performed by an optical measuring device.

20. The method according to claim 12, wherein a frequency used in the inductive low-frequency or high-frequency pressure welding process is selected from a range between 0.05-2.5 MHz.

21. The method according to claim 12, wherein at least two different frequencies are induced during the inductive low-frequency or high-frequency pressure welding process.

22. The method according to claim 12, wherein the component is a BLISK or BLING.

23. A component manufactured according to the method of claim 12, wherein the component is a BLING or BLISK.

24. A method for replacing an individual element of a gas turbine component, comprising the steps of
a) removing a damaged individual element from the gas turbine component, wherein the gas turbine component include a wear-resistant and/or erosion-resistant layer;
b) feeding and aligning a replacement element relative to the gas turbine component; and
c) connecting the replacement element to the gas turbine component, with the wear-resistant and/or erosion-resistant layer included on the gas turbine component, by an inductive low-frequency or high-frequency pressure welding process.

25. The method according to claim 24, wherein the replacement element includes a same wear-resistant and/or erosion-resistant layer as the gas turbine component.

26. The method according to claim 24, wherein the damaged individual element includes a same wear-resistant and/or erosion-resistant layer as the gas turbine component.

27. The method according to claim 24, further comprising the step of coating the replacement element with a same wear-resistant and/or erosion-resistant layer as the gas turbine component after the connecting step.
